(19) United States
(12) Patent Application Publication
(10) Pub. No.: US 2007/0231580 A1
(43) Pub. Date: Oct. 4, 2007

(54) Process for the preparation of powder coatings on heat-sensitive substrates

(76) Inventors: Martin Louis Holliday, Richmond (GB); Steven Philip Hobbs, Darlington (GB); Marie Eke, Bellingham (GB)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/731,175

(22) Filed: Mar. 30, 2007

Related U.S. Application Data
(60) Provisional application No. 60/787,248, filed on Mar. 30, 2006.

(51) Int. Cl. B32B 27/38; B05D 1/06; C08L 63/00

(52) U.S. Cl. 428/413; 427/422

(57) ABSTRACT

A process for preparation of powder coatings on substrates comprising the following steps of a) applying a powder coating composition onto the substrate surface comprising 40 to 90 wt % of at least one epoxy resin having an epoxy equivalent weight in the range of 1000 to 5,000, 10 to 60 wt % of at least one cross-linking (curing) agent, 0.1 to 15 wt % of at least one inclusion catalyst and 0.01 to 40 wt % of at least one constituent selected from additives, pigments and/or fillers, the wt % based on the weight of the powder coating composition, b) fusing, melting and flowing out the particles of the powder coating composition under increased temperature to a molten coating, and c) curing the molten coating; the one-component stable powder coating forms smooth and up to fine texture coatings and has improved flow and eliminates post-cure edge cracking and has a high opacity, hardness and flexibility.

### CROSS-REFERENCE TO RELATED APPLICATION

This application claims the benefit of U.S. Provisional Application Ser. No. 60/787,248 filed on Mar. 30, 2006 which is hereby incorporated by references in its entirety.

### FIELD OF THE INVENTION

The invention relates to a process of preparation of powder coatings on heat-sensitive substrates with enhanced properties using powder coating compositions including specific catalysts.

### DESCRIPTION OF RELATED ART

A number of low temperature curable powder coatings have been developed for heat-sensitive substrates such as, wood, fibreboard and plastics. The use of catalysts to reduce the curing temperature and/or curing time is limited by the fact that the difference between extrusion temperature during the manufacture of the powder formulation and the curing temperature of the powder formulation is small, which may lead to gelation during the extrusion process. In addition, solid-state reactions between the catalyst and the powder formulation resin may have a negative impact on the storage stability of the powder formulation. “Latent” catalysts have been developed to overcome the limitations of conventional catalysts. Latent catalysts are catalysts which are encapsulated by, e.g., waxes, polymers and microgels, or which are blocked by some means of chemical modification, and, therefore having no catalytic activity during processing and storage of the powder formulation, but are reactive under low temperature curing conditions.

In U.S. Pat. No. 3,819,560 latent catalysts are disclosed, such as imidazoles, for the use in epoxy adhesive systems. EP-A 326230 and EP-A 504732 describe latent catalysts or catalysts in complex form for powder formulations curable at low temperature resulting in coatings with good curing property and storage stability. EP-A 1348742 disclosures coating powders comprising encapsulated catalysts provide stable one-part compositions.

Another possibility to overcome the limitations of conventional catalysts is the use of “inclusion” catalysts. Such catalysts are based on a complex of included so-named “guest” molecules within the crystal lattice of so-named “host” molecules. By breaking the crystal lattice, by, e.g., increasing temperature, the guest molecules are released and are able to perform their function, e.g., as catalyst. Host molecules are, for example, hydroxyphenyl ethane derivatives, for example, tetrakis hydroxyl phenyl ethane (TEP). Guest molecules can be, for examples, amines. Powder coating formulations containing inclusion catalysts provide one-component stability, accelerated curing and curing under lower temperatures.

However, these technical solutions are often difficult to control or inefficient, and they lack specific coating properties.

### SUMMARY OF THE INVENTION

The invention relates to a process for the preparation of powder coatings on substrates comprising the following steps of:
a) applying a powder coating composition onto the substrate surface comprising 40 to 90 wt % of at least one epoxy resin having an epoxy equivalent weight in the range of 1000 to 5,000,10 to 60 wt % of at least one cross-linking (curing) agent, 0.1 to 15 wt % of at least one inclusion catalyst and 0.01 to 40 wt % of at least one constituent selected from the group consisting of additives, pigments and/or fillers conventional in powder coating technology, the wt % based on the weight of the powder coating composition,
b) fusing, melting and flowing out the particles of the powder coating composition under increased temperature to a molten coating, and
c) curing the molten coating.

The process according to the invention makes it possible to provide one-component stable powder coatings that form smooth and up to fine texture coatings. Improved coating properties are obtained, such as, superior flow and the elimination of post-cure edge cracking and the coating has a high opacity, hardness and flexibility. The process according to the invention is especially useful for coating of heat-sensitive substrates due to its low temperature curing and is suitable also for use under ultra low-bake stoving conditions.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges. In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

In step a) of the process according to the invention, a powder coating composition based on the above mentioned quantity and kind of the epoxy resin, the cross-linking agent and the catalyst is applied onto the substrate surface by means of techniques known to a person skilled in the art.

Following step a) of the process of invention, the particles of the powder coating composition are fused, molten and flowed out under increased temperature. This can be done, e.g., by IR-radiation, IR-radiation combined with hot-air convection, or hot-air convection. IR radiation includes also Near-Infrared radiation (NIR). Typically IR radiation uses wavelengths in the range of 0.76 μm to 1 mm and NIR radiation used wavelengths in the range of 0.76 to 1.2 μm. The melting temperature, for example, may be in the range of 60 to 120° C., measured as substrate surface temperature, and dependent on the kind of powder coating composition.

Following step b), the molten powder coating is cured. This can be done by exposing the applied and melted powder coating layer to thermal energy. The coating layer may, for example, be exposed by convective and/or radiant heating to temperatures of, for example, 60 to 150° C., measured as substrate surface temperature, and dependent on the kind of powder coating composition. Also, ultra low bake stoving conditions known by a person skilled in the art may be applied in this curing step.

Exposing to thermal energy before, during and/or after irradiation with high energy radiation is also possible.

If the composition according to the invention is used together with unsaturated resins and, optionally photo-initiators or with unsaturated resin containing powders, dual curing may also be used. Dual curing means a curing method of the powder coating composition according to the invention where the applied composition can be cured, e.g., both by high energy radiation such as, e.g., ultra violet (UV) irradiation, and by thermal curing methods known by a skilled person.

The powder coating composition usable according to the invention contains 40 to 90 wt %, preferred 45 to 80 wt % of one or more epoxy resins, selected from the group consisting of reaction products prepared from epichlorohydrin with bisphenol, for example, bisphenol A; epoxy novolac resins, functionalized resins, such as, (meth)acrylated epoxides or epoxy polyesters.

The epoxy equivalent weight of the resins is in the range of 1000 to 5000, preferably 1200 to 2000.

Examples of epoxy binders curable by free-radical polymerization under high energy irradiation include those based on, for example, unsaturated epoxides, unsaturated (meth)acrylated epoxies, unsaturated epoxy polyesters.

(Meth) acrylic is respectively intended to mean acrylic and/or methacrylic.

The epoxy resins can also be at least one self crosslinkable resin containing cross-linkable functional groups known by a person skilled in the art.

The cross-linking agents may include conventional curing agents suitable for the epoxy resins known by a person skilled in the art. Examples are amines, polyamines, amides, dicyanodiamide, phenols, carboxylic acids, anhydrides and carboxyl terminated polyesters.

The cross-linking agent is used in quantities in the range of 10 to 60 wt %, preferred 20 to 50 wt % in the powder composition.

The powder coating compositions of this invention contain 0.1 to 15 wt %, based on the weight of the powder coating composition, of at least one inclusion catalyst. Preferred is a content in a range of 1 to 10 wt % based on the powder coating composition.

Suitable inclusion catalysts are, for example, TEP complexes with cycloaliphatic, aliphatic and aromatic imidazoles and amines, such as, TEP complexes with ethyl methyl imidazoles, methyl imidazoles, benzyl methyl imidazoles, amino propanes. Preferred is the use of TEP complexes with aliphatic and cycloaliphatic imidazoles.

The powder coating compositions may contain as further components the constituents conventional in powder coating technology, such as, additives, pigments and/or fillers as known by a person skilled in the art.

Additives are, for example, degassing auxiliaries, flow-control agents, flatting agents, texturing agents, fillers (extenders), photoinitiators, catalysts, dyes. Compounds having anti-microbial activity may also be added to the powder coating compositions.

The powder coating compositions may contain photo-initiators in order to initiate the free-radical polymerization. Suitable photo-initiators include, for example, those which absorb in the wavelength range from 190 to 600 nm. Examples for photo-initiators for free-radically curing systems are benzoin and derivatives, acetophenone and derivatives, benzophenone and derivatives, thioxanthone and derivatives, anthraquinone, organo phosphorus compounds, such as, for example, acyl phosphine oxides. The photo-initiators are used, for example, in quantities of 0 to 7 wt %, relative to the total of resin solids and photo-initiators. The photo-initiators may be used individually or in combination.

The powder coating compositions may comprise pigmented or un-pigmented powder coating agents for producing any desired coating layer of a one-layer coating or a multilayer coating. The compositions may contain transparent, color-imparting and/or special effect-imparting pigments and/or extenders. Suitable color-imparting pigments are any conventional coating pigments of an organic or inorganic nature. Examples of inorganic or organic color-imparting pigments are titanium dioxide, micronized titanium dioxide, carbon black, azopigments, and phthalocyanine pigments. Examples of special effect-imparting pigments are metal pigments, for example, made from aluminum, copper or other metals, interference pigments, such as, metal oxide coated metal pigments and coated mica. Examples of usable extenders are silicon dioxide, aluminum silicate, barium sulfate, and calcium carbonate.

The constituents, are used in conventional amounts known to the person skilled in the art for example, based on the total weight of the powder coating composition, regarding pigments and/or fillers in quantities of 0 to 40 wt. %, preferred 0 to 35 wt %, and regarding the additives in quantities of 0.01 to 5%, preferred 1 to 3 wt %.

The powder coating composition may contain also further binder resins, such as, for example, additionally thermosetting resins, such as polyester, (meth) acrylic and/or urethane resins, in amounts of, e.g., 0 to 10 wt %, relative to the total resin solids.

The powder coating compositions are prepared by conventional manufacturing techniques used in the powder coating industry. For example, the ingredients used in the powder coating composition, can be blended together by, for example, dry-blend mixing, and they can be heated to a temperature to melt the mixture and then the mixture is extruded. It is possible to use extrusion temperatures in a range of, for example, 100 to 130° C. The extruded material is then cooled on chill roles, broken up and then ground to a fine powder, which can be classified to the desired grain size, for example, to an average particle size of 20 to 200 μm.

The powder coating composition may also be prepared by spraying from supercritical solutions, NAD “non-aqueous dispersion” processes or ultrasonic standing wave atomization process.

Furthermore, specific components of the powder coating base according to the invention, for example, the inclusion catalyst, additives, pigment, fillers, may be processed with the finished powder coating particles after extrusion and grinding by a “bonding” process using an impact fusion. For this purpose, the specific components may be mixed with the powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g., the glass transition temperature Tg of the composition, in a range, of e.g., 50 to 60° C. After cooling the mixture the desired particle size of the resulted particles may be proceed by a sieving process.

The powder coating composition of this invention may be applied by electrostatic spraying, thermal or flame spraying, or fluidized bed coating methods, all of which are known to those skilled in the art.

The powder coating process according to the invention is suitable for coating metallic substrates, for example, large metal objects, and/or non-metallic substrates, as one-layer coating or as a coating layer in a multi-layer film build.

The powder coating process is especially suitable for coating heat-sensitive substrates such as, for example, wood, fibre-boards, for example, medium density fibre (MDF) boards, fibre-inforced plastic parts, paper, cardboards, plastics.

The substrate can be preconditioned prior to powder coating application. Preconditioning is performed in order to increase the conductivity of the substrate surface and, therefore, promote successful powder deposition. Preconditioning can be achieved by various means known by a person skilled in the art, for example, by preheating the substrate. Gas is commonly used for various heating steps, but other methods, e.g., microwaves, IR or NIR are also known. Also, a primer can be applied, which seals the surface and provides the required electrical conductivity. UV-curable primers are also suitable to us.

What is claimed is:

1. A process for the preparation of powder coatings on substrates comprising the steps as follows
a) applying a powder coating composition onto the substrate surface comprising 40 to 90 wt % of at least one epoxy resin having an epoxy equivalent weight in the range of 1000 to 5,000, 10 to 60 wt % of at least one cross-linking (curing) agent, 0.1 to 15 wt % of at least one inclusion catalyst and 0.01 to 40 wt % of at least one constituent selected from the group consisting of additives, pigments; fillers and any mixtures thereof conventional in powder coating technology, the wt % based on the weight of the powder coating composition,
b) fusing, melting and flowing out the particles of the powder coating composition under increased temperature to a molten coating, and
c) curing the molten coating.

2. The process according to claim 1 wherein the substrates are heat-sensitive substrates.

3. The process according to claim 1 wherein the epoxy resin of the powder coating composition has an epoxy equivalent weight in the range of 1200 to 2000.

4. The process according to claim 1 wherein the inclusion catalyst comprises TEP complexes with aliphatic and cycloaliphatic imidazoles.

5. Coated substrate prepared by the process according to claim 1.
